(19) United States
(12) Patent Application Publication
(10) Pub. No.: US 2005/0132581 A1
(43) Pub. Date: Jun. 23, 2005

(54) Crystalline substance with tailored angle between surfaces

(76) Inventor: Jeffrey R. Jessing, Boise, ID (US)

Correspondence Address: PEDERSEN & COMPANY, PLLC, P.O. BOX 2666, BOISE, ID, 83701, US

(21) Appl. No.: 10/898,663

(22) Filed: Jul. 23, 2004

Related U.S. Application Data
(60) Provisional application No. 60/489,951, filed on Jul. 23, 2003.

(51) Int. Cl. B28D 1/02

(52) U.S. Cl. 30/350; 76/104.1

(57) ABSTRACT

A crystalline manufacture and process for creating the same are disclosed wherein an end surface is etched along an etch-resistant plane in the crystalline structure of substance in which the top and bottom surfaces have been sliced off-axis from the crystal plane at a specified angle. The end surface may form a blade edge of a blade if the end surface is etched all the way from the top surface to the bottom surface. This results in a linear blade edge wherein the angle between the blade edge and the bottom surface may be chosen by selecting the off-axis orientation of the crystalline substance from which the manufacture is created.

This Application claims priority based on Application Number 60/489951, filed Jul. 23, 2003, the disclosure of which is herein incorporated by reference.

### BACKGROUND OF THE INVENTION

1. Field of the Invention

The present invention relates to a crystalline substance having a tailored angle between a bottom surface and an end surface, and processes for manufacturing the same.

2. Related Art

Steel and tungsten have been used to manufacture blades, but have amorphous and jagged edges caused by the manufacturing methods used to grind the metal to create and sharpen the edge. These defects are shown in the scanning electron microscope image of a high performance, new steel blade, shown in FIG. 1. These precarious, dull, and amorphous edges unnecessarily traumatize tissue when used in surgery.

Diamond knives, cut from gem quality single-crystal stones, are currently the sharpest blades available. Most of the common blade styles of steel blades are available, as well as enhanced designs that include multi-faceted angles. Diamond knives are manufactured by grinding one diamond against another until the desired blade edge is formed, which significantly adds to the initial expense of the material. FIG. 2 shows examples of smaller style diamond blades used primarily for various types of surgical incisions. These blades are approximately one millimeter wide and six millimeters in length, and have a radius of curvature of approximately 500 Angstroms. FIG. 3 is a magnified image of a diamond blade typically used in cataract surgery.

Silicon wafers have also been used to manufacture micromachined cutting blades. When silicon is manufactured in small pieces, such as the size of a typical surgical blade, its intrinsic yield strength exceeds that of high-strength steel. Marcus, U.S. Pat. No. 5,842,387, discloses a method of forming a knife blade which has a curved knife blade. A representation of such a curved knife blade is shown in FIG. 4.

However, the crystalline nature of silicon allows it to be manufactured with linear edges, the linear edges corresponding to planes residing in the crystalline structure. The three-dimensional atomic crystalline structure of silicon is the same as that of the carbon atoms of real diamond, which structure is called the diamond lattice. This arrangement is shown in FIG. 5. The plane in which the surface density of the silicon atoms is maximized is denoted the (111) plane using Miller indices.

Certain chemical solutions, referred to as orientation-dependant etchants, etch silicon, as well as other crystallographic substances, preferentially in specific crystallographic directions. For example, potassium hydroxide, KOH, etches silicon extremely slowly in the direction normal to the (111) plane relative to other directions.

De Juan, U.S. Pat. No. 3,317,938, discloses a method of making a microsurgical cutter from a flat planar substrate.

Mehregany, U.S. Pat. No. 5,579,583, discloses a cutting edge in a single-crystal silicon wafer from the intersection of the (100) plane and the (111) plane, resulting in a blade having an angle of 54.74 degrees.

Fleming, U.S. Pat. No. 6,615,496, discloses a cutting blade defined by the intersection of {211} crystalline planes of silicon with {111} crystalline planes of silicon, resulting in a cutting blade which has a cutting angle of 19.5 degrees.

However, no one has yet invented a means for etching silicon at a tailored angle from the surface plane, which allows one to tailor the angle of the end of the resulting blade or other manufacture.

### SUMMARY OF THE INVENTION

The present invention relates to a crystalline substance wherein the angle between the top and bottom surfaces and the end surface may be tailored to a chosen angle, and processes for manufacturing the same. A crystalline substance is obtained which has been cut off-axis at a chosen angle with respect to a plane which is etch-resistant to orientation-dependant etching. The crystalline substance is then etched along the etch-resistant plane resulting in an end surface which is substantially parallel to the etch-resistant plane. This results in a crystalline substance wherein the angle between the bottom surface and the end surface is the chosen angle.

### BRIEF DESCRIPTION OF THE DRAWINGS

The accompanying drawings illustrate several aspects of the present invention and the related art. The drawings are for the purpose only of illustrating the related art and preferred modes of the invention, and are not to be construed as limiting the invention.

FIG. 1 is a scanning electron microscope image of a prior art high performance, new steel blade.

FIG. 2 shows examples of smaller style prior art diamond blades used primarily for various types of surgical incisions.

FIG. 3 is a magnified image of a prior art diamond blade typically used in cataract surgery.

FIG. 4 is a representation of a non-linear edge blade.

FIG. 5 shows the crystalline arrangement of silicon atoms.

FIG. 6 is a scanning electron microscope image of a cross-section of a silicon blade with a linear cutting edge embodying the present invention.

FIG. 7 is another scanning electron microscope image of a silicon blade with a linear cutting edge embodying the present invention.

FIG. 8 is a scanning electron microscope image of s silicon blade showing the linear cutting edge.

FIG. 9 shows representations of a single-bevel blade embodiment and a double-bevel blade embodiment of the present invention.

FIG. 10 shows a representation of an embodiment of the present invention which may be used in LASIK surgery.

FIGS. 11A through 11F represent a cross-section of a batch showing one blade among many being made according the preferred mode one-mask process of the present invention.

FIGS. 12A through 12J represent a cross-section of a batch showing one blade among many being made according to an alternative mode two-mask process of the present invention.

FIG. 13 shows a top view of the alternative mode two-mask process of the present invention just prior to the second masking step.

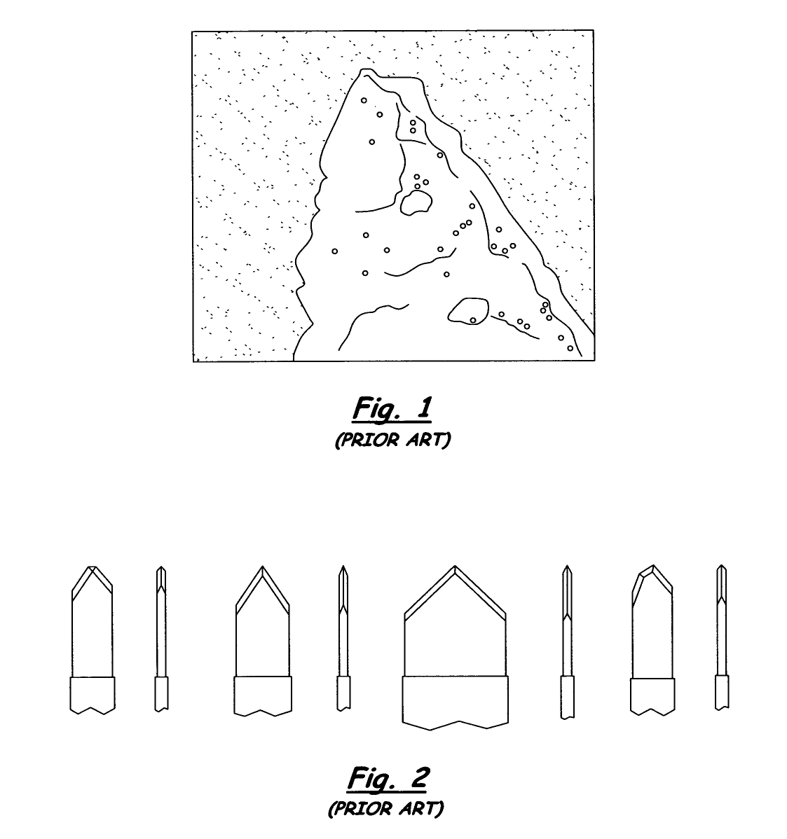

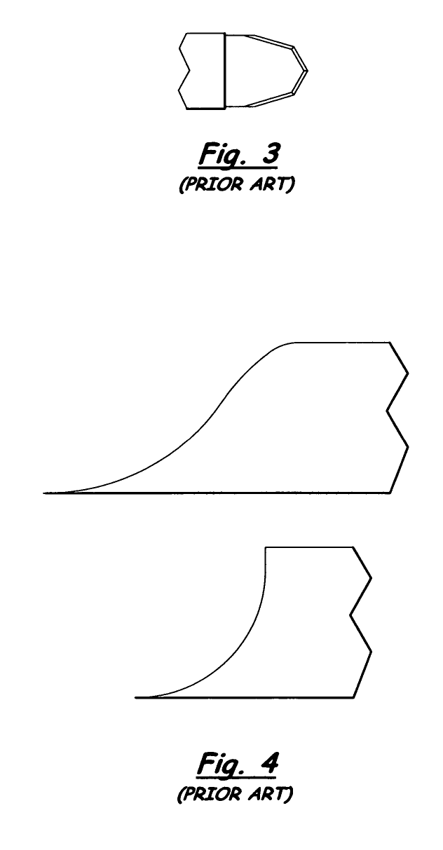

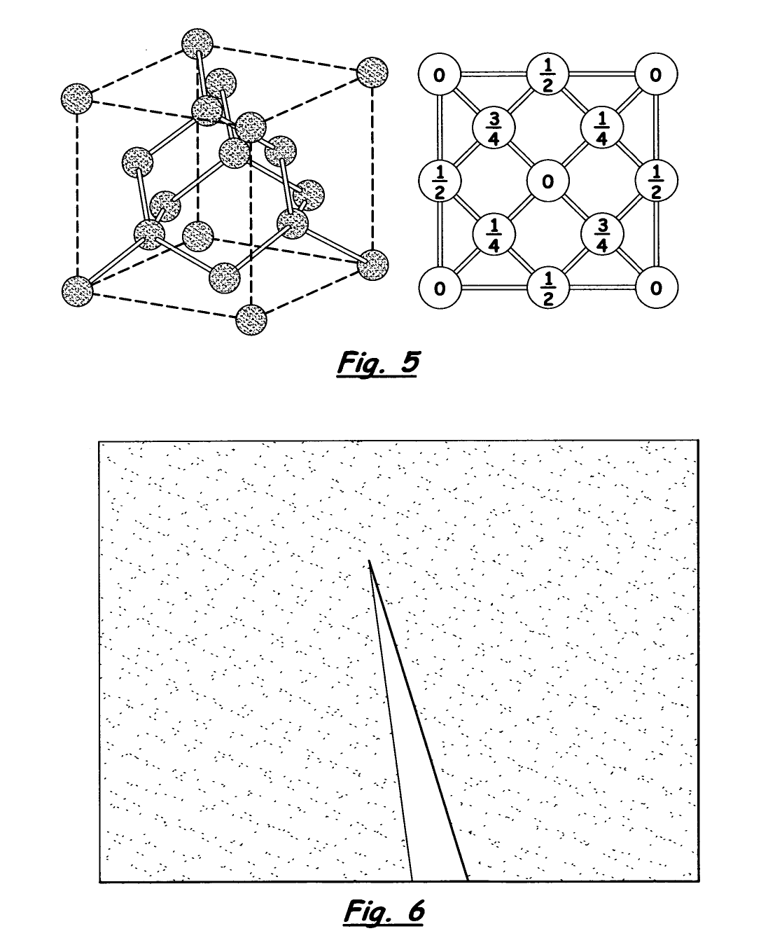

### DESCRIPTION OF THE PREFERRED MODES

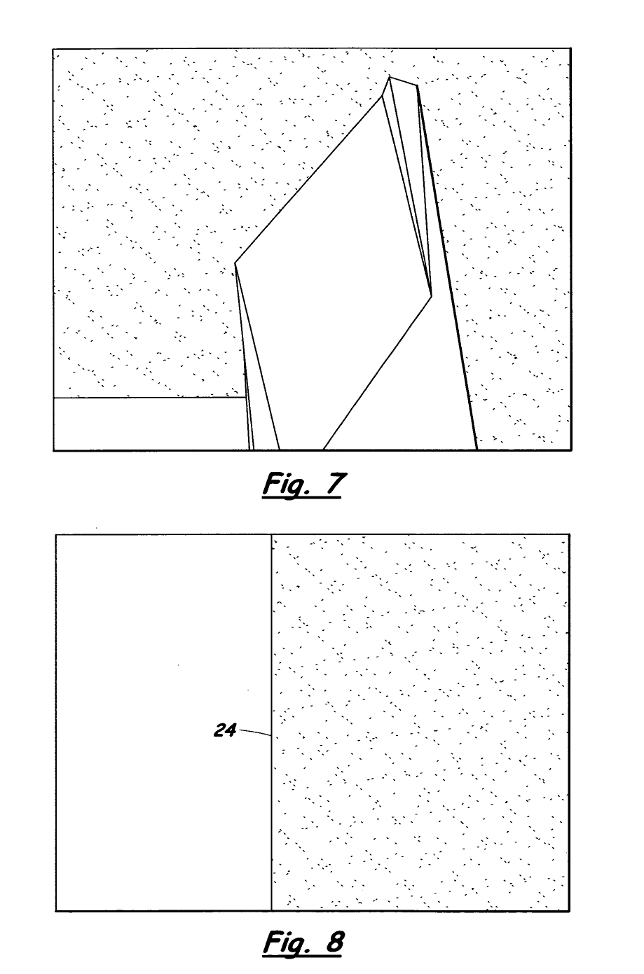

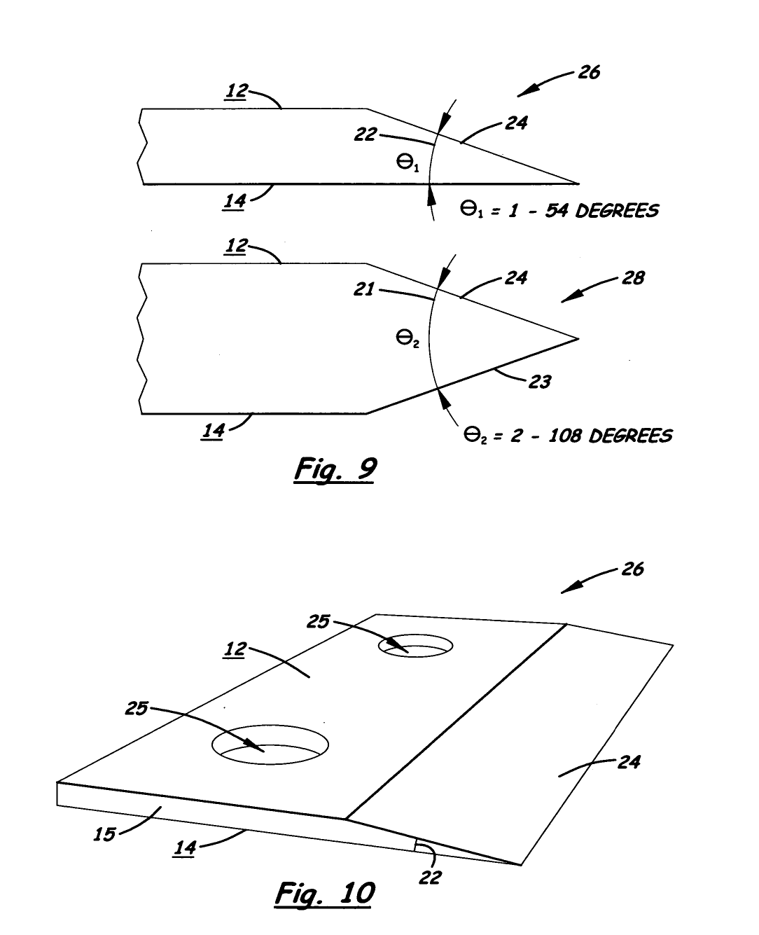

The preferred mode of the invention is to create a blade 26. FIGS. 6 and 7 are scanning electron microscope images of a silicon blade with a linear cutting edge embodying the present invention, FIG. 8 is a scanning electron microscope image of a silicon blade showing the linear cutting edge that may be achieved using orientation-dependent etching, and FIGS. 9 and 10 are representations of blades embodying the present invention.

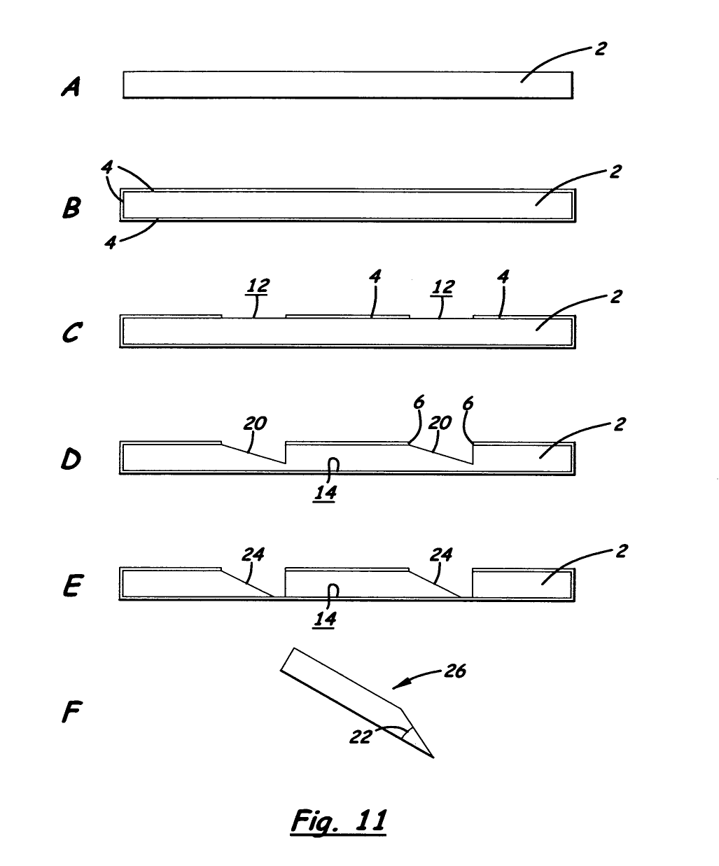

The preferred mode is illustrated in FIGS. 11A through 11F. According to the preferred mode, a silicon wafer 2 is obtained which has been sliced off-axis with respect to the (111) plane. It is also envisioned that the invention could be applied to other crystalline substances, such as semiconductor materials, including silicon carbide and germanium, and also including crystalline metals, such as titanium and nickel, as well as crystalline insulators. Crystallographic substances each have etch-resistant planes along which they can be orientation-dependently etched. Silicon can be orientation-dependently etched along two planes, including the (111) plane.

The chosen angle at which the wafer 2 has been sliced off-axis from the plane along which it will be orientation-dependently etched, in the preferred mode using silicon the (111) plane, will be the angle 22 of the blade edge 24 from the bottom surface 14 of the blade 26 which is ultimately formed. Manufacturers are able to slice wafers 2 off-axis with such precision that the angle 22 can be selected to a tenth of a degree. This allows one to create blades 26 with any chosen angle 22. The angles 22 of most interest will be between four and twenty-five degrees, matching the angles of commercially available steel and diamond blades. The wafer 2 will have a double-sided polish at the time it is obtained. The thickness of the wafer 2 corresponds to the thickness of the blade 26 that will be manufactured. In the preferred mode, a 250 micrometer-thick wafer 2 is used, which results in a 250 micrometer-thick blade 26, corresponding to the thickness of steel LASIK blades. However, the wafer 2 could be chosen so that the blade 26 will be any thickness, for example, 1.5 millimeters, 5.0 millimeters, or even greater than a centimeter.

The wafer 2 must then be masked. In the preferred mode, a thin layer of low-stress silicon nitride, Si₃N₄, is deposited on all surfaces of the wafer 2 using low-pressure chemical vapor deposition. The silicon nitride is used as an etch-mask 4 for the subsequent orientation-dependent etching step. While silicon nitride is used in the preferred mode, other masking materials, such as silicon dioxide, SiO₂, could also be used. Low-stress silicon nitride is used as the etch-mask 4 in the preferred embodiment because it can be deposited directly on both sides of a silicon wafer 2 without excessively high film-stress, it can be patterned using well understood fabrication processes such as photolithography and either wet or dry etching techniques, and it remains intact during the aggressive orientation-dependent etching of silicon.

The next step of the preferred mode is to photolithographically pattern the wafer 2. While photolithography is the preferred mode, other forms of lithography could be used. The etch-mask 4 on the top surface 12 of the wafer 2 is coated with a photoresist in the pattern of the blade 26. A plasma etch system is then used to etch the pattern onto the etch-mask 4 on the top surface 12 of the wafer 2. In the preferred mode, the gases carbon tetrafluoride, CF₄, and molecular oxygen, O₂, are used to plasma etch the etch-mask 4. However, other forms of dry etching, as well as wet etching techniques, could be used to plasma etch the pattern onto the etch mask.

The photoresist is then removed, using, in the preferred mode, wet chemical resist strippers. Other techniques, such as dry etching, could also be used to remove the photoresist.

At this point, the blade edge 24 is ready to be formed.

The final step is to orientation-dependently etch the blade edges 24 into the wafer 2, which divides the wafer 2 into separate pieces. In the preferred mode, the orientation-dependent etching is accomplished by anisotropically etching the wafer 2 using an aqueous solution of potassium hydroxide, KOH, at 60 to 80 degrees Celsius. While 60 to 80 degrees Celsius is the preferred temperature range, potassium hydroxide can be used to etch the wafer at other temperatures. This causes an etch-front 20 to propagate along the (111) plane which begins at the end 6 of the etch-mask 4. Because of the relatively low etch rate of off-axis (111) silicon in potassium hydroxide, this step can take several hours to complete. Once the etch-front 20 propagates through the entire wafer 2 to the bottom surface 14, the blade edge 24 has been formed. The blade edge 24 corresponds to the etch-front 20 once the etch-front 20 has propagated to the bottom surface 14. Because of the spacing between the blade patterns on the etch-mask 4 and the geometry of the etch-front 20, the blades 26 are now separately formed and ready for characterization, quality control, and packaging. The side and back surfaces will also have been etched along equivalent (111) planes, and they will be close to perpendicular to the top surface 12 and to the bottom surface 14.

FIG. 10 is a representation of a blade 26 with apertures 25 for insertion into a knife according to the preferred mode of the present invention which may be used, for example, in LASIK surgery. This blade 26 with apertures 25 may be made according to the preferred mode described above either by adding a second masking step, or the apertures may be patterned during the one masking step. However, when made with a single etching step, the apertures 25 and the sidewalls 15 are not etched normal to the top surface 12. Further, because etching takes place along the crystallographic planes of the wafer 2, the apertures 25 will not be circular, but will be polygonal. The apertures 25 may or may not extend all the way from the top surface 12 to the bottom surface 14.

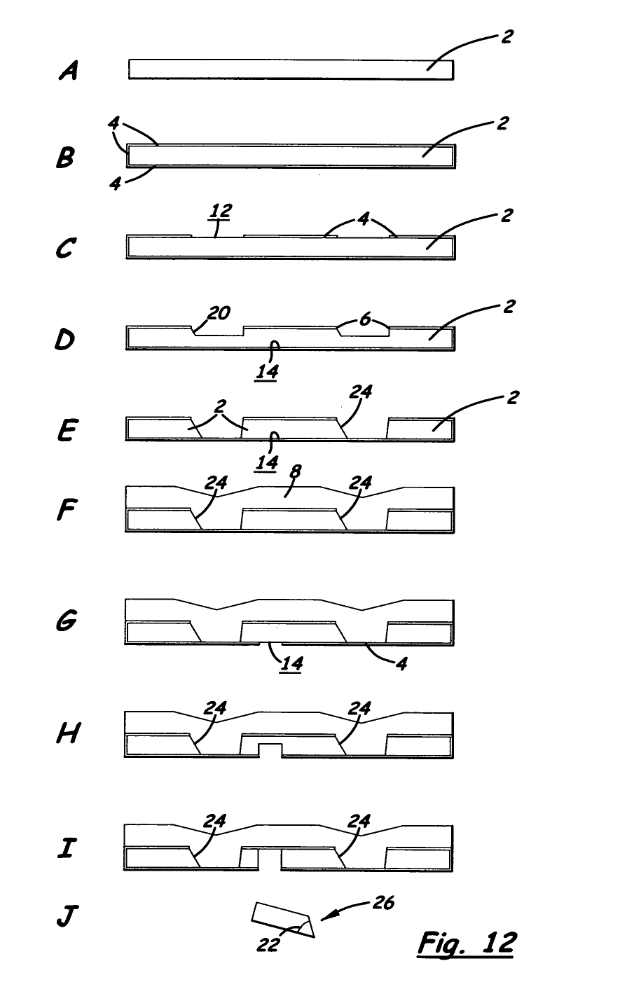

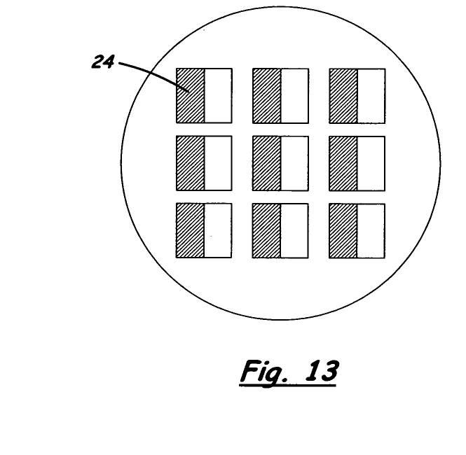

In an alternative two-mask mode, illustrated by FIGS. 12A through 12J, the blade edges 24 will have been formed, but the side and back surfaces will not have formed. At this point the top view of the wafer appears as illustrated in FIG. 13. It is thus necessary, after the foregoing steps have been completed, to etch the side surfaces and back surfaces of the blades. FIGS. 12A through 12E illustrate the foregoing steps as applied to the alternative mode, and correspond to FIGS. 11A through 11E illustrating steps of the preferred mode. FIGS. 12F through 12J illustrate the following steps.

Following the etching of the blade edge 24 in the alternative mode, a protective substance is applied to the top of the wafer 2. In this alternative mode, the protective substance is a thick photoresist 8, generally thicker than fifty micrometers. The primary purpose of the thick photoresist 8 is to protect the blade edges 24 during the following steps.

The etch-mask 4 on the bottom surface 14 of the wafer 2 is then coated with a thin layer of photoresist. This photoresist is patterned to form the side surfaces and back surfaces of the blades 26. Photolithography will again be used to generate an end of the blade pattern opposite the blade edge 24 onto the etch-mask 4 on the bottom surface 14 of the wafer 2. In the alternative mode herein described, this photolithography step is performed using a backside infrared alignment system.

The etch-mask 4 on the bottom surface 14 of the wafer 2 is then plasma etched, using carbon tetrafluoride and molecular oxygen in this alternative embodiment to pattern the back surface and side surfaces of the blades 26. Once this pattern is formed, a deep reactive ion etch, such as Bosch etching, is performed. The Bosch etch is a plasma anisotropic etching process that yields vertical, straight sidewall profiles that can be hundreds of micrometers in depth. This Bosch etch process etches completely through the 250 micrometer wafer 2 used in this alternative mode, freeing the blades 26. This process could also be performed from the top surface 12 of the wafer 2.

After this Bosch etch process is complete, wet chemistry is used in this alternative mode to dissolve the thick photoresist 8 and remove the remaining etch mask 4. At this point, the blades 26 are fully formed and ready for characterization, quality control, and packaging.

The application of these modes results in a silicon blade 26 that is characterized by a linear blade edge 24, as shown in FIGS. 6 and 7, and similar to that shown in FIG. 8. Further, by selecting the angle at which the wafer 2 is sliced off-axis relative to the plane along which it will be etched, the manufacturer thereby selects the angle 22 of the blades 26 which will ultimately be manufactured.

In less preferred modes, double-bevel blades 28 and multi-bevel blades may be manufactured by orientation-dependently etching blade edges 23, 24, along more than one plane. FIG. 9 compares a single-bevel blade 26 to a double-bevel blade 28.

These modes allow the manufacturer to select any angle 22 between the blade 26, 28, and the bottom surface 14. The manufacturer is not restricted to particular angles 22 at which two crystallographic planes intersect, such as 19.5 degrees or 54.7 degrees, but may select any angle 22 he or she chooses. Thus, the angle 22 of a single bevel blade could be chosen as 0.5 degrees, 2.0 degrees, 4.6 degrees, 10.2 degrees, 19.4 degrees, 19.6 degrees, 28.0 degrees, 54.6 degrees, etc. The angle 21 of a double bevel blade could be up to 109.3 degrees.

These modes of the invention result in high-performance surgical blades. Advantages of a blade 26, 28, with a linear blade edge 24 with a tailored angle 22 include less trauma to the tissue, decreased inflammatory response, flatter corneal bed during refractive surgery, superior flap creation during LASIK, decreased risk of astigmatism during cataract surgery, the creation of better sealing incisions, improved wound healing process, a cosmetically superior scar, and reduced healing time. In the laboratory, use of these superior blades 26, 28, could help to prepare thinner sections, achieve superior histological outcomes, or hasten the laboratory preparation process by yielding superior results during serial or single sections.

Applications of the blades 26, 28, according to these modes of the invention include scalpels for microsurgery, retinal membrane peels, cosmetic surgery, laparoscopy or arthroscopy, microkeratomes used during corneal procedures such as LASIK, microkeratomes used for tissue preparation in laboratories, household knives, assembly lines for manufacturing processes, box-cutting, industrial utility knives, seam rippers, cutting delicate objects in space, scissors or microscissors, trimmers and high leverage shears, tweezer edges, micropics for microsurgery, and electric shaving devices.

An advantage of using silicon, or other crystalline substances, to form blades 26, 28, in addition to the ability to yield uniformly sharp blade edges 24, is the cost-reduction associated with batch processing.

Other uses of the process herein described may include micromachined structures such as mirrored surfaces, micromachined inclines, and micromachined orifices and nozzles. These micromachined structures could be manufactured by etching the wafer 2 all the way from the top surface 12 to the bottom surface 14, or without etching the wafer 2 is all the way from the top surface 12 to the bottom surface 14, but instead creating a series of parallel linear indentations.

Although this invention has been described above with reference to particular means, materials and embodiments, it is to be understood that the invention is not limited to these disclosed particulars, but extends instead to all equivalents within the scope of the following claims.

1. A manufacture comprising:
a crystallographic substance having a top surface, a bottom surface, and an end surface;
wherein neither the top surface nor the bottom surface is substantially parallel to an etch-resistant plane along which the crystallographic substance can be orientation-dependently etched;
wherein if the crystallographic substance is silicon, then neither the top surface nor the bottom surface is substantially parallel to a (211) plane; and
the end surface is substantially parallel to the etch-resistant plane.

2. The manufacture of claim 1 wherein the crystallographic substance comprises a semiconductor material.

3. The manufacture of claim 1 wherein the crystallographic substance comprises silicon.

4. The manufacture of claim 1 wherein the crystallographic substance comprises germanium.

5. The manufacture of claim 1 wherein the crystallographic substance comprises silicon carbide.

6. The manufacture of claim 1 wherein the crystallographic substance comprises a crystalline metal.

7. The manufacture of claim 1 wherein the crystallographic substance comprises titanium.

8. The manufacture of claim 1 wherein the crystallographic substance comprises nickel.

9. The manufacture of claim 1 wherein the crystallographic substance comprises a crystalline insulator.

10. The manufacture of claim 1 wherein the distance from the top surface to the bottom surface is less than one millimeter.

11. The manufacture of claim 1 wherein the distance from the top surface to the bottom surface is equal to or greater than one millimeter and equal to or less than two millimeters.

12. The manufacture of claim 1 wherein the distance from the top surface to the bottom surface is greater than two millimeters and equal to or less than ten millimeters.

13. The manufacture of claim 1 wherein the distance from the top surface to the bottom surface is greater than ten millimeters.

14. The manufacture of claim 1 wherein the end surface extends all the way from the top surface to the bottom surface.

15. The manufacture of claim 14 wherein the manufacture is adapted to function as a cutting instrument.

16. The manufacture of claim 15 further comprising apertures.

17. The manufacture of claim 14 wherein the manufacture is adapted to function as a razor.

18. The manufacture of claim 14 wherein the manufacture is adapted to function as a scalpel.

19. The manufacture of claim 1 wherein the manufacture is a single-beveled blade.

20. The manufacture of claim 1 wherein the manufacture is a double-beveled blade.

21. The manufacture of claim 1 wherein the manufacture is a blade comprising three or more bevels.

22. A manufacture comprising:
a crystallographic substance;
wherein the crystallographic substance has been sliced between 0.1 degrees and 19.4 degrees off-axis relative to an etch-resistant plane along which the crystallographic substance can be orientation-dependently etched; and
the crystallographic substance has an end surface which is substantially parallel to the etch-resistant plane.

23. A manufacture comprising:
a crystallographic substance;
wherein the crystallographic substance has been sliced between 19.6 degrees and 54.6 degrees off-axis relative to an etch-resistant plane along which the crystallographic substance can be orientation-dependently etched; and
the crystallographic substance has an end surface which is substantially parallel to the etch-resistant plane.

24. A process comprising:
orientation-dependently etching a crystalline substance along an etch-resistant plane;
wherein the crystalline substance has been sliced off-axis between 0.1 degrees and 19.4 degrees relative to the etch-resistant plane.

25. The process of claim 24 wherein the etching is anisotropic etching.

26. The process of claim 24 wherein the crystalline substance comprises a semiconductor substance.

27. The process of claim 24 wherein the crystalline substance comprises silicon.

28. The process of claim 24 wherein the crystalline substance comprises silicon carbide.

29. The process of claim 24 wherein the crystalline substance comprises germanium.

30. The process of claim 24 wherein the crystalline substance is etched all the way from a top surface of the crystalline substance to a bottom surface of the crystalline substance.

31. The process of claim 24 wherein an end surface of the crystalline substance extends from a top surface of the crystalline substance to a bottom surface of the crystalline substance.

32. The process of claim 24 wherein the crystalline substance is etched using potassium hydroxide.

33. The process of claim 24 wherein the crystalline substance has a double-sided polish.

34. The process of claim 24 wherein orientation-dependently etching the crystalline substance comprises:
applying an etch-mask to a top surface of the crystalline substance;
applying a photoresist to the etch-mask;
etching the etch-mask; and
orientation-dependently etching the crystalline substance from the top surface to form an end surface.

35. The process of claim 34 further comprising orientation-dependently etching the crystalline substance to form apertures.

36. A process comprising:
orientation-dependently etching a crystalline substance along an etch-resistant plane;
wherein the crystalline wafer has been sliced off-axis between 19.6 degrees and 54.6 degrees with respect to the plane.

37. A manufacture comprising:
a crystallographic substance other than silicon;
wherein the crystallographic substance has been has been sliced off-axis relative to an etch-resistant plane along which the crystallographic substance can be orientation-dependently etched; and
the crystallographic substance has an end surface which is substantially parallel to the etch-resistant plane.
